(19) United States
(12) Patent Application Publication
(10) Pub. No.: US 2022/0407835 A1
(43) Pub. Date: Dec. 22, 2022

(54) Boom! Message Chat Application

(71) Applicants: Samuel Zean, Brooklyn Park, MN (US); Eunice Zean, Brooklyn Park, MN (US)

(72) Inventors: Samuel Zean, Brooklyn Park, MN (US); Eunice Zean, Brooklyn Park, MN (US)

(21) Appl. No.: 17/446,151

(22) Filed: Aug. 26, 2021

Related U.S. Application Data
(60) Provisional application No. 63/259,133, filed on Jun. 22, 2021.

(51) Int. Cl. H04L 12/58

(52) U.S. Cl. CPC H04L 51/36; H04L 51/32

(57) ABSTRACT

A system and method for providing a multi-feed mobile chat platform for separate business and personal uses to a plurality of client devices. The system communicatively connects a web server and the plurality of client devices over the Internet. The client devices operate a mobile application in which the client device has a memory having instructions stored thereon, a processor configured to execute the instructions within a mobile application in the memory to cause the electronic client device to send and receive message from other users, and the mobile application comprises a set of software components including a message generator, a user command processor, a normal post component, a schedule-a-post component, a direct messaging component, a fun chat dialog component, a live streaming component, a vanishing message component, a recipient verification or confirmation component, a billboard message component and a buy and sell incentivized marketplace component.

### CROSS-REFERENCE TO RELATED APPLICATION

This application claims priority to U.S. Patent Application No. 63/259,133, titled “Boom Message Chat Application,” and filed on Jun. 22, 2021. The entire application is incorporated herein by reference in its entirety.

### TECHNICAL FIELD

This application relates in general to a system and method for providing a social media chat application, and more specifically, to a system and method for providing a multi-feed mobile chat platform for separate business, professional and personal or private uses.

### BACKGROUND

Many different social media applications provide users with a mechanism to chat with others while online. These existing applications typically provide only a single organization of the social media feed for all users, whether for business, professional or personal communications, regardless of the intended uses of the messages posted onto the social media feed. This arrangement requires users to either mix different chat messaging uses, including, business-related formal uses, professional-related formal uses and personal or private informal uses, into a single feed that may be difficult to configure for its intended use, or to require use of different social media applications for each of the intended uses.

Additionally, social media applications and platforms in general do not provide users with any mechanism that employs an inventive concept or method that reminds or prevents users from texting or messaging the unintended recipient(s). The feature introduces a brand new and viable solution to a major problem and headache that is repeatedly faced or experienced daily by nearly all social media users worldwide across platforms in sending chats, text messages and contents to the unintended recipients. And in many instances, before a user realizes the mistake, it is often too late, even if the user returns to a feed to delete the content or message which is already seen, captured, screenshotted, copied or uploaded by the unintended recipient(s) or shared to others on the internet or shared via other methods. This invention will now enable users to be automatically reminded, alerted via a visual and auditory indication to prevent users from sending text, chats, or messages, including content-related messages such as photos, videos, and file attachments to an “unintended recipient(s)” usually within chat/messaging forums from users' contact lists, friends' lists, and on group chats etc.

Additionally, social media applications and platforms in general do not provide users with any mechanism that employs an inventive concept or method to chat, including creating and sending messages, contents, or images using predefined chat stickers and/or face filters that employs a new, unique, creative and different kind of messaging or chatting called “Fun Chats” that enables users to type on/in predefined chat stickers and/or face filter to create and send stylistic chats/messages in any form, shape, style, or design, that includes but are not limited to invitation chats, consolation chats, consolidatory chats, complimentary chats, congratulatory chats, love or romantic chats or messages wherein recipients of said “Fun Chats” will experience an animated speech bubble pop messages or chats with optional BOOM or Pop alerts, including in other “Fun Chats” messaging formats that introduces a new and different kind of chatting/messaging to the social media space.

Additionally, social media applications and platforms in general do not provide users with an inventive concept or mechanism that would enable or give users the ability to preschedule a post or share a content in advance of when a user want the content to be automatically posted on a feed or to a recipient. The ability to upload a content or post to a recipient or on a feed now and the post automatically shares at the user's predetermined date and time. By setting a timer to a predetermined date and time in advance of certain major events, sales, or marketing, including to auto post timely contents, including invitations, consolation, consolidatory, complimentary or congratulatory messages at the present but said messages or content are automatically shared at a later date and time chosen by users. Once the timer has elapsed on the predetermined date and scheduled time, the post(s) will automatically share on the feed to the intended recipient(s) or feed even when the sender of the post(s) was off-line at the time that the post was shared, sleeping, working, sporting, vacationing, or traveling. Some users of the social media feed would benefit from an ability to preschedule a post and have posted messages or content be automatically deleted after the message has been seen by the intended recipient(s). For example, businesses could benefit using “Scheduled Post” or “Prescheduled Post” combined with “Time-Limited Post” for time-limited postings that advertise time-limited deals to customers receiving the social media postings. The business may wish to pre-post their advertising contents in advance of certain sales events, wherein said advertising contents are automatically posted later at the command of a timer and have said scheduled postings automatically delete after a pre-determined length of time or to delete the postings upon command of its author when the limited deal is no longer available. With the ability to preschedule posts that can post advertising, sales or marketing contents and pre-deleting these posting at certain times after the posts are seen by customers who follow the business' postings, the businesses can create an incentive for customers to follow and routinely view the postings made by the businesses. Such interest by the customers may increase interest in the business within the market of potential customers. Currently, while some social media chat platforms may give users the ability to send time-limited messages, that is as far as their use of technology is employed. No current social media platform uses a technology that gives users the ability to preschedule a post, content, or message in advance of the desired share date and time of said post, content, or message and that can also be preset to auto-delete at a preferred predetermined date and time.

Therefore, a need exists for a system and method for providing all of the above, including providing a multi-feed mobile chat platform for separate business, professional and personal uses according to the present invention. The present invention attempts to address the existing limitations in a system and method for providing all of the above, including for providing a multi-feed mobile chat platform for separate business, professional and personal uses according to the principles and example embodiments disclosed herein.

### SUMMARY

In accordance with the present invention, the above and other problems are solved by providing a multi-feed mobile chat platform for separate business, professional and personal uses according to the principles and example embodiments disclosed herein.

In one embodiment, the present invention is a system for providing a multi-feed mobile chat platform for separate business, professional and personal uses. The system communicatively connects a web server and the plurality of client devices over the Internet. The client devices operate a mobile application in which the client device has a memory having instructions stored thereon, a processor configured to execute the instructions within a mobile application in the memory to cause the electronic client device to send and receive message from other users, and the mobile application comprises a set of software components including a message generator, a user command processor, a normal post component, a schedule-a-post component, a direct messaging component, a fun chat dialog component, a live streaming component, a vanishing message component, a recipient(s) verification or confirmation component, and a billboard message component.

In another aspect of the present invention, the mobile application further includes a user registration component, a social login component, a message search component, a user profile component, a create post component, add friend/follower component, an audio note component, an audio and video call component, a predefined chat sticker or face filter component, an emoji component, a themes/background component, and a friends list component.

In another aspect of the present invention, the message generator component receives user data from the user to create and edit a draft posted message before the user instructs the message generator component a to send the draft posted message to the social media web server.

In another aspect of the present invention, the message generator component utilizes the normal post component. to accept data from the user to create a draft message for transmission to the web server permitting the user to post on the feed by the time of creation.

In another aspect of the present invention, the message generator component utilizes the schedule-a-post component adds any user specified time data associated with the draft message to instruct the web server when to post the message onto one or more of the feeds.

In another aspect of the present invention, the schedule-a post component further includes an alarm component to provide a visual and auditory indication that a user defined alarm has passed.

In another aspect of the present invention, the message generator component utilizes the vanishing message component adds user specified deletion time data to the draft message before it is sent to the web server, the web server deletes the corresponding message when the specified deletion time is reached.

In another aspect of the present invention, the message generator component utilizes the recipient verification or confirmation component, recipient verification or confirmation data to a user's text input field via a visual and/or an auditory indication before a message or chat is created, initiated, and sent to the web server. The user's text input field detects when a user is about to create or initiate a chat or text message in the text input field and instantaneously alerts the user to verify the intended recipients of the intended message or content(s).

In another aspect of the present invention, the message generator component utilizes the direct messaging component accepts user data to create the above messages, transmits the messages to specified users, receives messages from other users, and presents all sent and received messages to the user.

In another aspect of the present invention, the message generator component utilizes the fun chat dialog component creates the chat messages, transmits the chat messages to specified users, receives chat messages from other users, and presents all set and received chat messages to the user.

In another aspect of the present invention, the message generator component utilizes the live streaming component accepts multi-media data that is to be streamed to other users, the Live Streaming component 140 can modify, improve, and enhance the streaming data before transmission including use of the Themes/Background component, the Predefined Chat Stickers and/or Face Filters component.

In another aspect of the present invention, the message generator component utilizes the billboard message component allows a user to create a listing to sell and item on the marketplace, communicate, and transact business with other users, and to search and view items contained in the marketplace

In another embodiment, the present invention is a method for providing a multi-feed mobile chat platform for separate business, professional and personal uses between a web server and a plurality of client devices communicatively connected over the Internet. The method receives user message data, the user message comprises user message content data, user specified message type data, user specified message modification data, and user specified message time data, generates a draft message using the user message data, when user specified message modification data contains predefined chat sticker or face filter instructions data, the method applies a predefined chat sticker or face filter to all images associated with the user contained in the draft message, when user specified message modification data contains predefined chat sticker or face filter instructions data, apply a background to all images associated with the user contained in the draft message, when user specified message time data contains message deletion instruction data, the method inserts a deletion time instruction into the draft message to cause the web server to delete the message at the data and time specified in the deletion time instruction, when user specified message time data contains message schedule instruction data, the method inserts a scheduled posting time instruction into the draft message to cause the web server to delete the message at the data and time specified in the deletion time instruction, and sends the draft message data, including any modifications to the draft message to the web server for inclusion in one of a plurality of message feeds.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for providing a multi-feed mobile chat platform for separate business and personal uses according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-c illustrate various personal chat feeds within a system for providing a multi-feed mobile chat platform for separate business and personal uses according to the present invention.

FIG. 4 illustrates a business chat feed within a system for providing a multi-feed mobile chat platform for separate business and personal uses according to the present invention

FIG. 5 illustrates a computing system of software components of a system for providing a multi-feed mobile chat platform for separate business and personal uses according to the present invention.

FIG. 6 illustrates a set of software components contained within a mobile application user command processor according to the present invention.

FIG. 7 illustrates a flowchart corresponding to a method performed by software components of a system for providing a multi-feed mobile chat platform for separate business and personal uses to the present invention.

### DETAILED DESCRIPTION

This application relates in general to a system and method for providing a social media chat application, and more specifically, to a system and method for providing a multi-feed mobile chat platform for separate business and personal uses according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The term “user” refers to an entity, e.g. a human, using a multi-feed mobile chat platform for separate business and personal uses including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s). Some examples are included below in this application.

The term “invention” or “present invention” refers to the invention being applied for via the patent application with the title “Boom Message Chat Application.” Invention may be used interchangeably with chat application.

The terms “communicate”, or “communication” refer to any component(s) connecting with any other component(s) in any combination for the purpose of the connected components to communicate and/or transfer data to and from any components and/or control any settings.

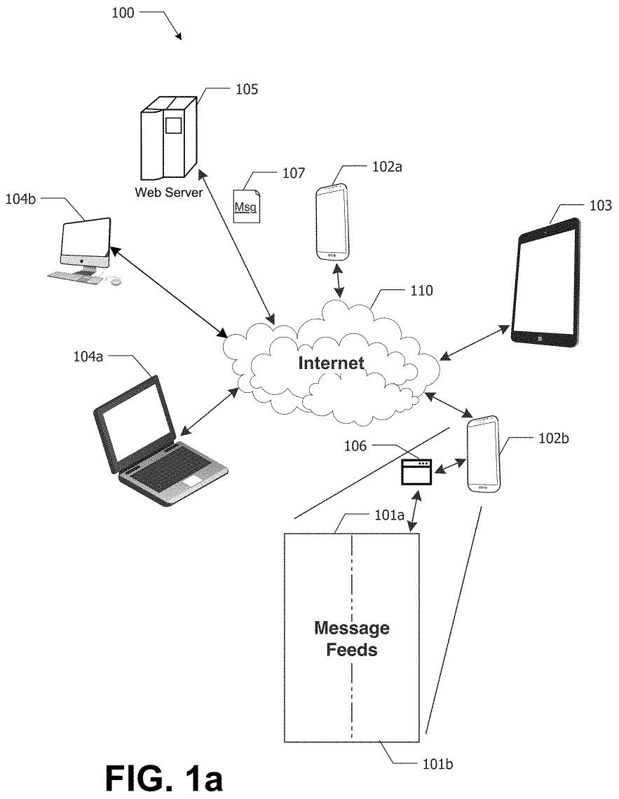

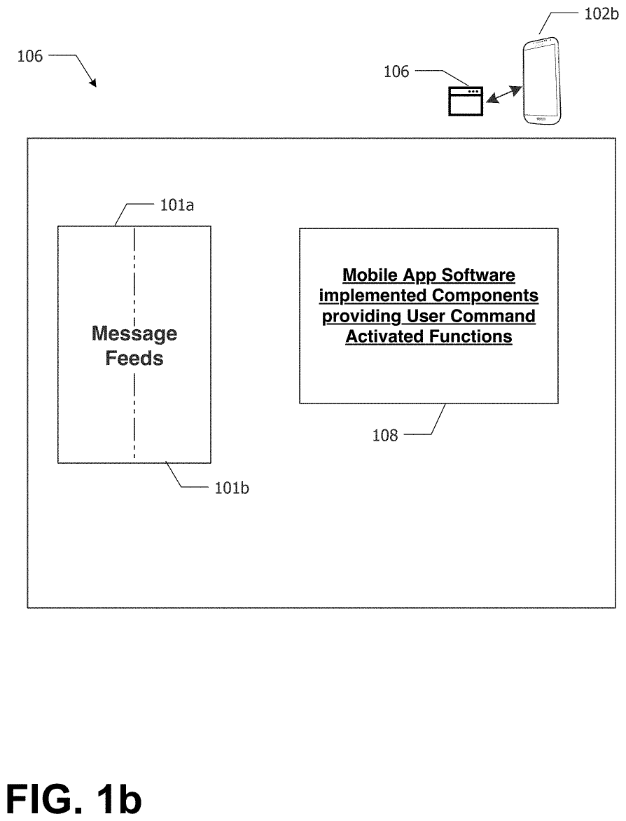

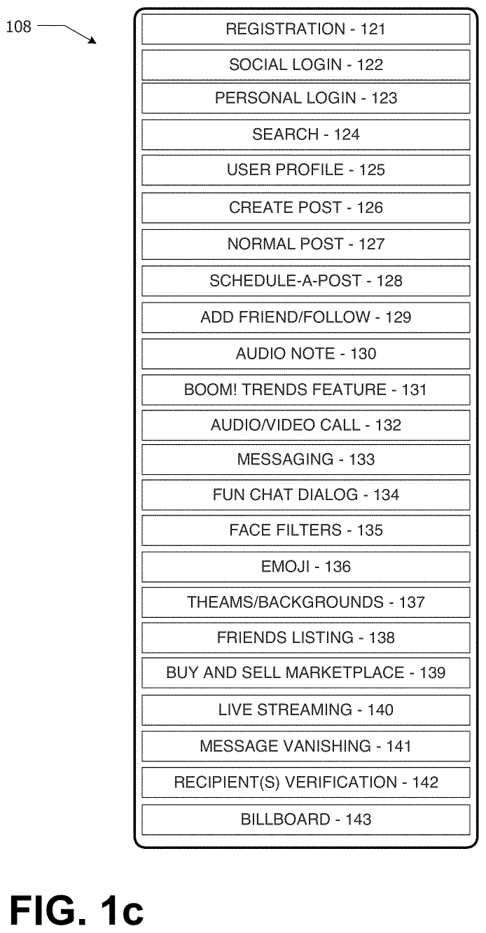

In general, the present disclosure relates to a system and method for providing a multi-feed chat platform. To better understand the present invention, FIG. 1 illustrates a system for providing a multi-feed mobile chat platform for separate business and personal uses according to the present invention. This invention relates to the development of a mobile and web messaging and chat application 106 that provides a different way users send and receive text messages, including the way users chat and message each other. In short, it adds interesting new, useful, and innovative features and a new method of chatting/messaging.

In the social media application 106, users of client devices 102a-b, 103-104 communicate with each other over the Internet 110 by sending and receiving messages with a web server 105. Each user may log into the social media platform 100 using the mobile application 106 on one of their computing devices. These computing devices may include mobile devices such as smartphones 102a-b and tablets 103 as well as general purpose computing devices such as laptop 104a and desktop 104b computing devices. Users post messages onto one of two social media feeds 101a-b in which the messages 107 are sent to the web server 105 and provided to other users on their respective social media feeds 101a-b.

The social media platform 100 has a formal feed 101a on this application 106 for posting marketing materials/messages, where users can view comment, like, and share the messages to other users who may receive messages posted by these users onto their own feeds. Any comments, likes, and shares of the original posted message 107 are maintained by the web server 105 and provided to all users when they view the particular message 107 on their respective feeds 101a.

Users are able to select options that allow their messages to automatically delete whether opened or unopened within 30 days. Users are given the option to automatically delete messages sent in Group Chat after 48 hours, whether or not a user has viewed the message yet.

Users also have a second informal messaging/chatting feed 101b that users can select when they want to chat and post a message. Users can select a formal, business feed 101a and an informal, personal messaging/chatting option/feed 101b interchangeably. The different feeds 101a-b are presented by the mobile application 106 within separate windows or display panes, each of which may be configured to present posted messages in different user-specified ways.

The social media platform 100 eliminates the need for users to install multiple apps, switch between apps, fill up the space on their devices 102a-b-103-104, slow device performance with huge megabyte storage, and open more social media accounts than necessary. For example, Boom Message 100 provides users an ability to provide live streaming of video and audio data within their messages on their respective feeds. Users on BOOM Message social media platform 100 are enabled with a switch of a button to allow others to see them or not see them watching a particular live streaming. Currently, there is no way or method in existing social media platforms of preventing others from seeing or knowing that a user who does not want to be seen, is watching the live streaming data feeds.

FIG. 1b shows components of the mobile application 106 that runs on client devices 102a-b. 103-104. The mobile application 106 provides a pair of social media feeds 101a-b as disclosed above. Additionally, the mobile application 106 provides a set of software components that implement and user-initiated commands implementing a set of functions 108. The set of software components 108, as shown in detail in FIG. 1c, comprises the following functions: Registration (Phone And Email) 121, Social Login 122, Personal Profile 123, Search 124, User profiles 125, Create Post 126, Normal Post 127, Schedule-A-Post 128, Add Friend/Follow 129, Audio Note 130, BOOM! Trends Feature 131, Audio/Video Call 132, BOOM! Messaging 133, Fun Chat Dialog 134, Predefined Chat Stickers/Face Filters 135, Emoji 136, Themes/Background 137, Friends Listing 138, BOOM! Incentivized Buy and Sell Marketplace 139, BOOM! Live Streaming 140, Messaging Vanishing 141, Recipient(s) Verifications or Confirmations 142, and BOOM! Billboard 143

These functions provide the mobile application 106 with an ability to implement the features of the social media platform 100 disclosed herein.

Registration component 121—Users will have the option to register via phone and email. The registration component 121 generates the registration data and sends the data to the web server 105 for processing.

Social Login component 122—User will have an option to sign up from via multiple social media platforms. The social login component 122 obtains user identification data from the user and/or one or more of the connected social media platforms for transmission to the web server 105 for authentication and authorization to access the user's account.

Personal Profile component 123—Application allows users to set their account via his verified number and valid email, it helps users to perform different activities which associate with his profile. The user profile component 123 accepts data, images, multi-media images and sound and includes that within the user's account data maintained by the web server 105. The user provided data may include text to be displayed on the user profile as well as related data specifying how the data and images may be configured and positioned within the user profile when viewed by any user of the social media platform 100.

Search component 124—Search on BOOM! 100 allows users to find people, friends, and groups to understand your target audiences on a deeper level. Users use BOOM! searching option for a glimpse into the platform's audiences. Search enables a user to dig into BOOM! trending topics. BOOM! Search enables a user to Discover What Shows Up When You Search BOOM! Hashtags.

User profiles component 125—A BOOM! profile is a user's personal account, where he or she can post updates, upload photos, share videos, maintain a friends list, and provide personal information. The user profile component accepts user provided data that may include text to be displayed on the user profile, images, and multi-media data, as well as related data specifying how the data and images may be configured and positioned within the user profile when viewed by any user of the social media platform 100.

Create Post component 126—Allows user for the first time ever on a social media app/platform to create post using two approaches. The create post component 126 works together with the normal post component 127 and Schedule-A-Post component 128 to accept user data to create a draft message and transmit the draft message for inclusion within the user's feed(s) at a specified time.

Normal Post component 127—The post which user can post on the feed by the time of creation. The normal post component 127 accepts data from the user to create a draft message for transmission to the web server 105.

Schedule-A-Post component 128—Schedule-A-Post is an inventive new feature that enables a user to post on the feed by setting a timer to a predetermined date and time in advance of certain major events to auto post timely complimentary or congratulatory messages. Once the timer has elapsed on the predetermined date and scheduled time, the post(s) will automatically share on the feed to the intended recipient(s) even when the sender of the post(s) was off-line at the time that the post was shared. The schedule-a-post component 238 adds any user specified time data associated with the post generated within the normal post component 127 to instruct the web server when to post the draft message onto one or more of the user's feeds 101a-b. The schedule-a post component further includes an alarm component to provide a visual and auditory indication that a user defined alarm has passed.

Add Friend/Follow component 129—In many ways, a BOOM! Friend is the same as a real-life friend. These are the people you hang out with, keep in touch with, care about, and want to publicly acknowledge as friends. These are not people you met or invited on BOOM! Friends on BOOM! social media platform 100 can see a user's profile page, posts, uploads, and content. The user can also see your friend's profile page, posts, uploads, and content. Following on BOOM! social media platform 100 refers to the list of users that you follow on BOOM social media platform 100; these other users' posts appear on a user's feed, and the user has access to view their profile if they want the same as friends. The user can direct message these users, but if they do not follow the requesting user back the other users may have to approve the message before responding. The same is true with any other user's friends. The Add Friend/Follow component 129 accepts input data from the user and sends messages to the web server 105 to implement the above functions.

Audio Note component 130—BOOM! voice messaging allows users to instantly communicate with contacts and groups. Users can use it to deliver important and time-sensitive information. As such, all voice messages are downloaded automatically. The Audio Note component 130 records an audio data from the user, allows for editing and improvement of the data that is to be sent to the web server 105. The web server provides recipient users with access to the audio data when these users are on the social media platform 100.

BOOM! Trends Feature component 131—Users will be able to post trends/media or other textual content on their profile to show friends what's trending on their pages and will be able to see what is trending on the profile pages of their friends. The Trends Feature component 131 communicates with the web server 105 to request a set of trends data. The web server 105 uses the user's identity to generate a set of trends data associated with the corresponding user pages that is returned to the Trends Feature component 131. The Trends Feature component 131 also presents the set of trends data to the user in one or more user specified manners based upon friends and followers profiles, user specified topics, and other user defined criteria.

Audio/Video Call component 132—User enable to do voice call/video call within chat. The Audio/Video Call component 132 sets up and conducts the voice/video calls including establishing a connection to other users, receiving user audio and video data from the user, transmitting the user audio and video data to other users connected to the call, receive one or more data streams from connected users containing the other user's audio and video data, presenting all incoming data streams of other user's audio and video data to the user, and maintaining and terminating the call connections with other users during the call.

BOOM! Messaging component 133—Professional or Business messaging feed that enables users to send audio, video, and images as an attachment. For the first time ever, users are enabled to have astonishing feature of dialog boxes in which users have the option to select the desirable design boxes with respect to shapes, sizes, colors, themes, and backgrounds. The Messaging component 133 accepts user data to create the above draft messages, transmits the draft messages to specified users, receives responsive messages from other users, and presents all sent and received messages to the user.

Fun Chat component 134—gives users an inventive new method to chat including editing and sending images using predefined stickers or filters for creating and sending instant fun messages, chats, invitations, including creating and sending consolation chats, consolidatory, complimentary, congratulatory, love, or romantic chats/messages wherein recipients of said fun chat will experience an animated pop speech bubble message or chat including in other Fun messaging formats that introduces a new and different kind of chatting/messaging. The Fun Chat component 134 user data to create the above chat messages, transmits the chat messages to specified users, receives chat messages from other users, and presents all set and received chat messages to the user.

Predefined Chat Stickers and/or Face Filters component 135—Mix of either Predefined Chat Stickers, Cartoon, or characters face filter on BOOM! allow users to see what they would actually look like in fun chat when using face filter to chat or allows users select and type in a wide variety of predefined fun stickers designed for endless usage, styles, designs, occasions, and send chat messages using pop speech bubbles. BOOM! Introduces an inventive new way of stickering and filtering for sending instant fun messages, chats, invitations, including creating and sending consolation chats, consolidatory, complimentary, congratulatory, love, or romantic chats/messages. There are uniquely new chatting stickers or filters that render realistic looks wherein recipients of said fun chat will experience an animated speech bubble pop message or chat in the likeness/appearance of the predefined rendering used, including in other Fun messaging formats that introduces a new and different kind of chatting/messaging. The Predefined Chat Stickers and/or Face Filters component 135 works with the software components that send and receive draft messages of any type to include a user avatar or related user image, user video stream, user photos to generate images as described above before the corresponding draft messages are sent to the other users.

Emoji component 136—User will have the option to use emoticons for sharing their feelings while chatting with each other. Emoji component 136 accepts user commands to include one or more emoji within any of the disclosed messages, posts, and chats. The Emoji component 136 also accepts commands from users to send just one or emojis to other users as a separate message, post, or chat.

Themes/Background component 137—The user will be able to change background/themes with their desirable pictures or by default given in the app. Current chatting/messaging platforms greatly limit or otherwise, eliminates a user's ability to change background text colors options and/or themes in a chat dialog box or text input field where a user can text. The Themes/Background component 137 works with the software components that send and receive messages of any type to include a user avatar or related user image, user video stream, user photos to generate background images as described above before the corresponding messages are sent to the other users.

Friends Listing component 138—A user's interactions with those individuals on BOOM! Message, profile views, tagged photos, wall posts, likes, comments, viewed photos, private messages, mutual interactions, friends who are currently online, friends you've added to the “close friends” group and group chats. The Friends Listing component 138 maintains a list of other users that are friends and followers on the web server 105 to specify the other users to access and be provided posts, messages, and chats with the user. The Friends Listing component 138 also works with the software components that send and receive messages of any type to identify and address other users as described above before the corresponding messages are sent.

BOOM! Incentivized Buy and Sell Marketplace component 139—On BOOM! Users are incentivized by receiving automatic discounted prices across the platform for being users and for buying on the platform irrespective of the product or services offered on the platform. This business model also incentivized users who are sellers because it enables them to sell more of their goods and services for being users and sellers of the platform. Survey upon survey show that users will prefer to purchase items that are sold at discounted prices. Hence, this new business model which is the first of its kind not only on a chatting/messaging platform but across all platforms in general. Currently users who are both sellers and buyers on social media platforms are not incentivized to buy or for buying on a social media marketplace. Currently, no chat/messaging platform has a marketplace. Also, currently there are no inventive business (selling and buying) concept on any social media platform with a business model that is designed to allow or enable their users to view or consider their social media marketplace as the user's number choice or destination to shop, buy or sell. That is until now. A seller must be a registered user of the platform and must commit to offer discounts from a range of discount options that the seller is agreeing to offer the platform's general users when uploading or posting goods or services. When an item is uploaded or posted the selected discount that the seller selected is automatically applied to the item and is displayed on each item uploaded or posted for sale. Listed discount options are interchangeable and can vary by items. Upon entering a seller's Marketplace or page, a buyer is presented with the items for sales and selected discounts thereof for buyers to see. The seller can update or change the range of discount they selected from a dropdown discount menu and can replace with different discount options at any time. Examples of discount options are shown on page two or on the next page. A seller has the flexibility he or she may need to choose a discount option that is right for them per each item they are selling. A buyer can then call, email, or text the seller and arrange the purchasing of said items at the discounted rates. The BOOM! Incentivized Buy and Sell Marketplace component 139 allows a user to create a listing to sell and item on the marketplace, communicate, and transact business with other users, and to search and view items contained in the marketplace.

BOOM! Live Streaming component 140—Boom Message provides users an ability to provide live streaming of video and audio data within their messages on their respective feeds. Users on BOOM Message social media platform are enabled with a switch of a button to allow others to see them or not see them watching a particular live streaming. Currently, there is no way or method in existing social media platforms of preventing others from seeing or knowing that a user who does not want to be seen, is watching the live streaming data feeds. The Live Streaming component 140 accepts multi-media data that is to be streamed to other users. The Live Streaming component 140 may modify, improve, and enhance the streaming data before transmission including use of the Themes/Background component 137 and Predefined Chat Sticker or the Face Filters component 135.

Message Vanishing component 141—BOOM! unique feature enables end-user to have the option to set the conversation in a vanish mode by setting a timer to time limit. Once user turn on the vanish mode, the either the fun chat or BOOM! Messaging to disappear on the predetermined date and time the user set. The Message Vanishing component 141 interacts with the message, post, and chat components to add user specified deletion time data to a draft message before it is sent to the web server 105. The web server 105 will delete the corresponding message when the specified deletion time is reached. Once it is deleted, other users will not view the deleted messages when they interact with the social media platform 100.

Recipient(s) Verification or Confirmation component 142—Recipient(s) Verification or Confirmation is a new and inventive concept or method designed for a chat, messaging or text dialog box or text input field where a user can text, designed to remind or enable a user to be reminded or to prevent users from texting or messaging the unintended recipient(s). The feature introduces a brand new and viable solution to a major problem and headache that is repeatedly faced or experienced daily by nearly all cellphone, smartphone, smart device users and including social media users worldwide across devices and platforms in sending chats, text, messages and/or contents to an unintended recipient of said message, chat, or text. This feature is designed automatically remind, alert, or prevent users from sending text, chats, or messages, including content-related messages such as photos, videos, and file attachments to an “unintended recipient(s)” usually within chat/messaging forums from users' contact lists, friends list, and on group chats etc. irrespective to the devices or chat, messaging or texting forums being used. Surveys shows that about 70% of all chat, messaging, or texting users irrespective of device and/or forum often send text, chat, message, or content-related material to an unintended recipient(s) and often will attempt to delete the chat, message, text, or content minutes later or issue apologies. This feature addresses and solves this global problem. Most specifically, the “Recipient Verification” is the data or text display that is visual to a user in the text input field. Whenever a user grabs a device to type a message, to text or to chat, the user may experience any variety of signals, in any form or shape, that may indicate or signal to the user, “Verify Recipient,” or “Confirm Recipient” or “Verify Receiver,” or “Confirm Receiver” etc. and so forth. Said alert signal may display in any of the above catch phrases, or text or sound and may give a signal in any form or shape, or sound or alert, including but are not limited to the examples given above and example not illustrated here, including via a visual and/or an auditory indication. The alert signaling that a user should “Verify Recipient” or “Confirm Receiver” may blink or signal a couple of times for a few seconds to a user who intend to type, chat or text a message in the chat or text input field for the purpose of reminding the user to verify the user's intended recipient(s) or receiver(s) of the message or content. The text signal in the text input box or field signaling for a few seconds is intended to catch the eyes or attention of the user who intends to create and send a message. The blinking or signaling text or sound can be interrupted, disrupted, or override by a user who may override the signal by typing a text message or proceeding to chat in the text input field. However, if the user does not override the signaling text, or sound, the signaling text or sound will then fade away after a seconds and in the case of a signaling text, said text for example, such as “Verify Recipient,” or “Confirm Recipient” or “Verify Receiver,” or “Confirm Receiver” etc., may transform into a different but static default text that may read, “Type a Message,” “Type Here” or “Enter Message” as is in most mobile devices. A user may be enabled to customize or change a text or sound signal(s) as it relates to this feature or function or current invention. This invention or “Recipient Verification or Confirmation” component applies or is applicable to any mobile devices with a text or messaging input field, including but are not limited to apps, smartphones, and cellphones etc. The Recipient(s) Verification or Confirmation component 142 interacts with the message, post, and chat components to add user specified recipient verification requests or signal data to the text input field before a message is created and sent to the web server 105. The web server 105 detects when a specified user is about to chat or engage the text input field or the corresponding Recipient(s) Verification component 142 a read receipt which is subsequently provided to the user.

BOOM! Billboard component 143—A feed on BOOM! that enables users to post public communications, announcements, schedules and weather updates, news events, sporting events, ads & more. This feed is to be the first of its kind on a chatting platform and is primarily used for advertising, but it will also serve public service purposes including where users or marketers can advertise and post or upload personal and professional contents. The BOOM! Billboard component 143 receives user specified data to generate billboard messages that are to be sent to other users of the social media platform 100.

The present invention also may be deployed for individual use via a mobile application 106 which can be on a personal device, for example a smartphone 102a-b, a computer 104a-b, or a tablet 103, as this mobile application 106 may be utilized by people who cannot read or write but can speak a native language fluently. Mobile application developers may include the present invention within their applications as a mechanism to obtain feedback from users of these mobile applications.

The invention comprises a multi-feed mobile chat platform for separate business and personal use 100 to interact with users. The web server 105 and client computing system 102-104 may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

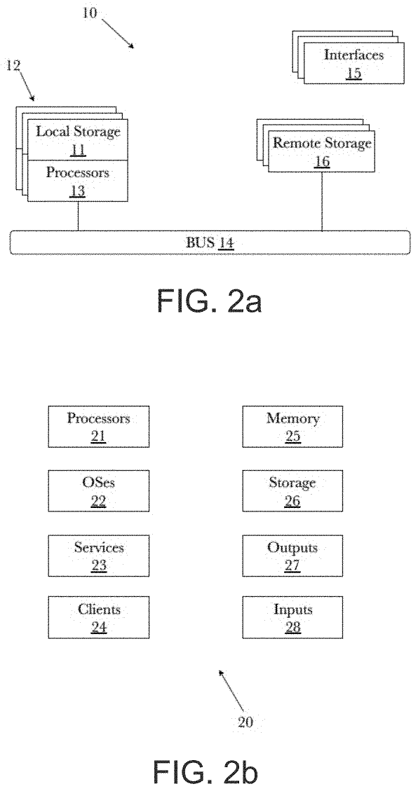

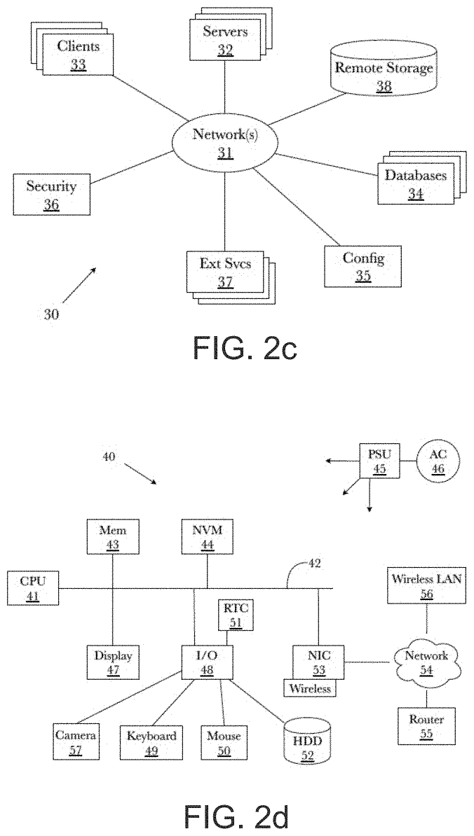

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet, or any other network, using known protocols for such communication, whether wireless or wired.

In one aspect, a computing device 10 includes one or more central processing units (CPUs) 12, one or more interfaces 15, and one or more buses 14 (such as a peripheral component interconnect (PCI) bus). When acting under the control of appropriate software or firmware, a CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including one or more levels of cached memory) may also form part of a CPU 12. However, there are many different ways in which memory may be coupled to a system 10. Memory 11 may be used for a variety of purposes such as caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

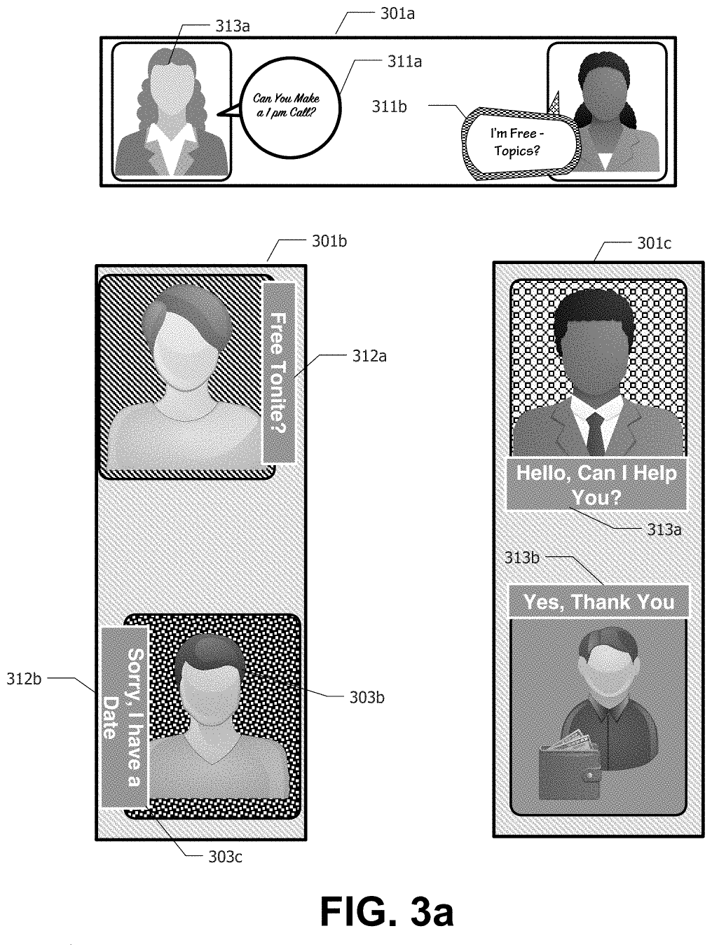

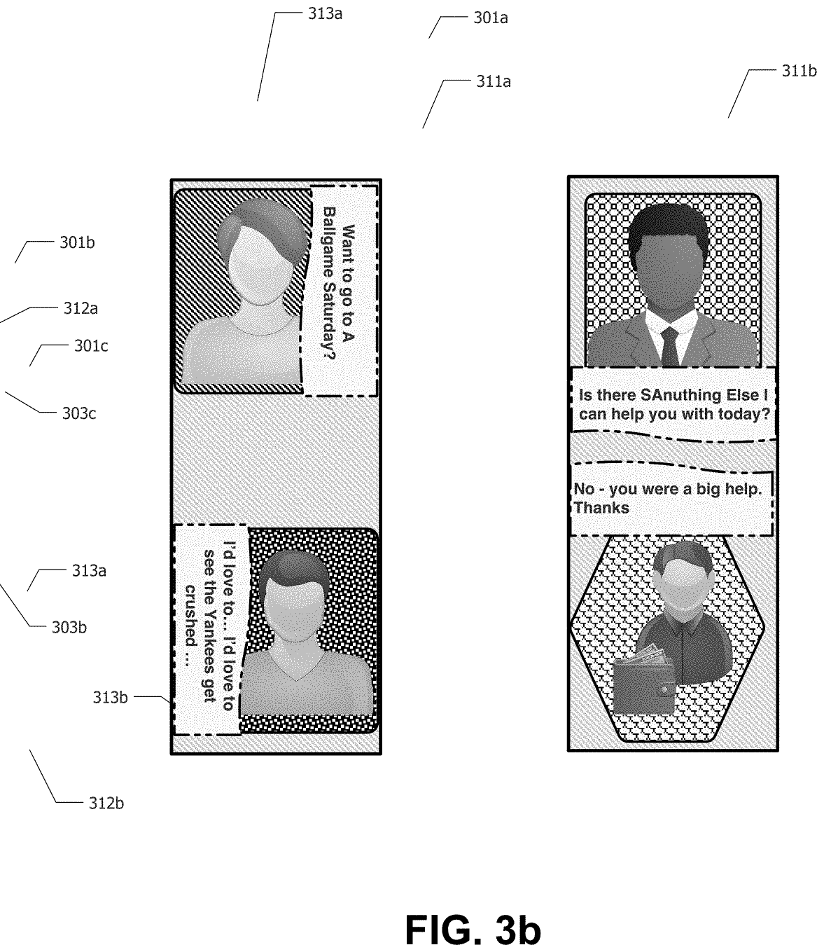

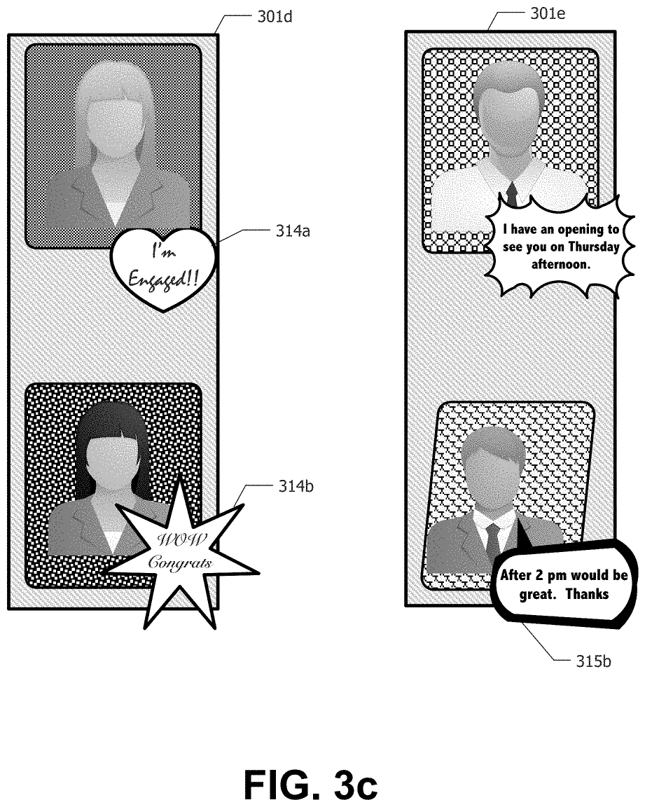

FIGS. 3a-c illustrate various informal and personal chat feeds within a system for providing a multi-feed mobile chat platform for separate business and personal uses according to the present invention. The informal messaging/chatting feed 101a which is the introduction of a new and Fun type of chatting/messaging designed for teens and is designed using animated speech pop bubbles 311a-b, wherein users are able to type and/or chat in a predefined chat sticker, and/or filter their profile image in a first embodiment of the informal social media feed 301a. In other embodiments of the informal social media feeds 311b-e, users may select shapes/frames for their snapshots and can select said shape/frame from a displayed bar etc., can apply with a predefined chat sticker and/or a filter 313a-n where all selections can merge and enable the user to type short chats/messages. The Predefined Chat Sticker and/or Filters 313a-n are a design overlay that users 314a-b and 315a-b may add on top of their snapshots in the shape/frame as shown in FIGS. 3a-c. Users are enabled to select the style of a speech bubble 311a-b as shown in different style formats. For example, users are given the option to select speech bubbles such as a cloud shape 311b, an oval shape 311a, rectangular with rounded corners shapes 313a-b, rectangular shapes 317a-b, round shape 317a, and love/heart shapes 316a-b and many similar shaped objects. When a recipient receives and opens a message, the speech bubble 311a should pop up from the mouth area of sender's avatar or profile image like animated speech pop bubbles with a puff/pop alert sound effect upon opening the message. Users can select alert tones from notification settings (not shown).

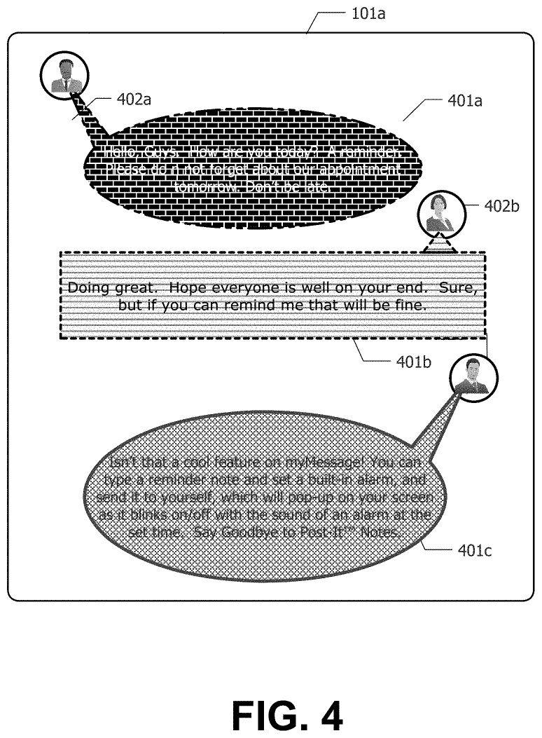

FIG. 4 illustrates a formal, business chat feed within a system for providing a multi-feed mobile chat platform for separate business and personal uses according to the present invention. The formal, business chat feed 101b is designed for formal/professional messaging where each user is able to change the color of his/her background and text 401a-c, including font, font size, and related characteristics, and present an avatar or profile photo 402a-c.

The posted messages 401a-c may include the above disclosed features such as, comment, likes, and shares, may include images and streaming media, and may have the ability to be deleted by the sender using defined parameters whether the posted message has been read by one or more of its recipients.

FIG. 5 illustrates a computing system of software components of a system for providing a multi-feed mobile chat platform for separate business and personal uses according to the present invention. The social media platform 100 may be implemented using a set of software components on the web server 105 and a separate set of software components in the mobile application 106 running on the users' client devices 102-104. The set of software components on the web server 105 includes a server controller 501, a server web interface 502, a feed generator 503, a user account manager 504, a message processor 505, a database engine 506, and a server data store 510.

The server controller 501 receives the user posted messages 107 via the server web interface 502 when it arrives from the mobile application 106. The server controller 501 coordinates the operation of the other software components 502-506 of the web server 105 to store incoming posted messages into the database 510 along with links to all social media feeds 101a-b that are currently receiving posted messaged from the source of the incoming posted messages 107, to retrieve all posted messages associate with each user's social media feeds 101a-b to generate feed data used by the mobile application 106 to display the contents of the feeds to the user, and manage the deletion of posted messages based upon user configured parameters.

The server web interface 502 permits the social media web server 105 to communicate with remote user computing devices and mobile devices 102a-b, 103, and 104a-b. The server web interface 502 performs all of the data formatting, computer-to-computer communications, encryption processing, and all similar operations needed by the social media web server 105 to communicate with users' mobile applications 106.

The feed generator 503 receives indication that a user has successfully logged into the social media platform 100 to initiate retrieval of posted messages 107 from the database engine 506 to generate the formal and informal message feeds 101a-b to be sent to the user via the mobile application 106. The feed generator 503 also provides updates to the formal and informal message feeds 101a-b for each user currently logged into the social media platform 100 when a posted message is received from a user that is to be included within the formal and informal message feeds 101a-b.

The user account manager 504 permits users to connect to and access the social media server 105. The user account manager 504 is responsible for creating and managing user accounts for the users of the mobile application 106. The user account manager 504 also is used in authenticating a user based upon user input. Typically, the user input uses a username and password. Multi-factor authentication, use of one-time passwords, and similar secure authentication mechanisms may be included in the user profile. For every sign in the system will recognize the user type, i.e. users of the mobile application 106, along with all past activities from account details in the database.

The message processor 505 receives a newly posted message 107 from a mobile application 106 for inclusion in a social media feed 101a-d associated with the sender. The message processor 505 sends the received posted message to the database engine for inclusion within the database 510 along with data identifying the social media feeds that are to include the received posted message when accessed by its corresponding user. The message processor 505 also detects whether or not the received posted message 107 contains deletion parameters that are interpreted to be provided to the database engine 506 when it is time to delete the received posted message 107.

The database engine 506 processes all database operations for the social media platform 100. These operations include insertion of user-posted messages received from users via the mobile application 106 into the database 510, deletion of user-posted messages from the database 510, searching and retrieving user posted message from the database 510 to generate various social media feeds, and indexing the database 510 to maintain efficient searching when needed.

The server data store 510 includes the database of posted messages 107 and all other data used by the server software components 510-506 to perform the disclosed operations.

The set of software components in the mobile application 106 includes a client controller 511, a client web interface 512, a user interface 513 coupled to input and output devices 521-522, a user command processor 514, a message generator 515, and a client device data store 520.

The client controller 511 sends the user posted messages 107 via the client web interface 512 to the social media web server 105 for the mobile application 106. The client controller 511 coordinates the operation of the other software components 512-516 of the mobile application 106 to generate and send new posted messages web server 105, to receive all posted messages associated with the user's social media feeds 101a-b, and to display the contents of the feeds to the user.

The client web interface 512 permits the mobile application 1061 to communicate with the social media web server 105. The client web interface 512 performs all of the data formatting, computer-to-computer communications, encryption processing, and all similar operations needed by the client devices to communicate with the web server 105.

The user interface 513 provides input and output processing to provide a mobile application user with messages and data needed to create and present social media feeds on the client devices 102-104. This interface module 513 communicates with coupled input and output devices 521-522 also accepts commands from the user to instruct the application to perform various tasks. The input and output devices 521-522 may include a display device 521 and a keyboard 522 or may provide these functions using a touch screen device of a smartphone 102a-b or a tablet 103.

The user command processor 514 receives user commands from the user interface 513 that are to perform operations within the mobile application 106. The performed operations may include sending a posted message generated in the message generator 515 to the web server 105, sending an instruction to delete a posted message, sending login commands to the web server 105, and instructing the message generator 515 to begin creation of a new posted message.

The message generator 515 receives user data from the user interface 513 to create and edit a draft posted message before the user instructs the client controller 511 to send the draft posted message 107 to the social media web server 105.

The client device data store 520 feeds data associated with posted messages 107 and all other data used by the client software components 511-515 to perform the disclosed operations.

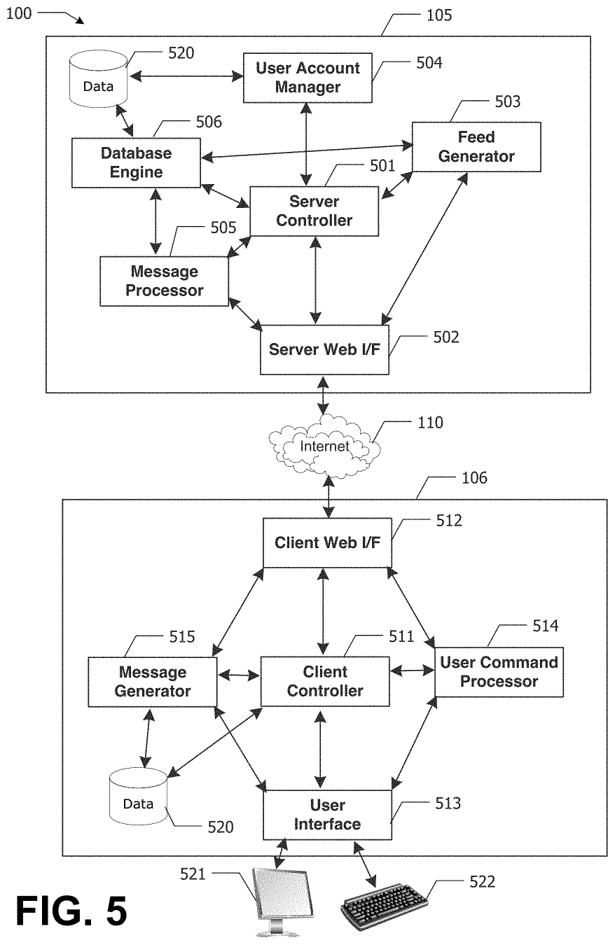

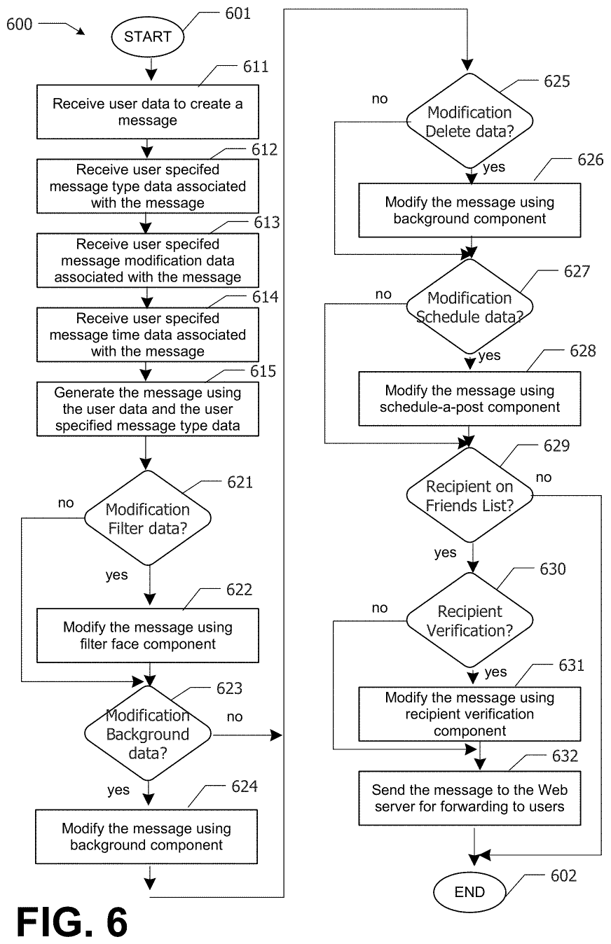

FIG. 6 illustrates a flowchart corresponding to a method performed by software components of a system for providing a multi-feed mobile chat platform for separate business and personal uses to the present invention. The process 600 begins 601 as the user provides user data to the mobile application 106 in step 611. This user data may include a request to send a message including text, images audio, and video data that are to be included in the message.

In step 612, the user provides the mobile application 106 message type data defining the type of message instructing the web server 105 to provide the message to the appropriate users of the social media platform. The type of message may comprise a public post message, a personal posted message, a direct message, a chat message, a multi-media audio and video stream, and a bulletin board message. Each type of message may include data specific to its type regarding how it may be view by recipients as well as visual formatting instructions as appropriate. The message type also defines on which feed the message is to be posted to provide access to the message to the appropriate and intended set of recipient users.

The mobile application 106 receives, in step 613, user specified modification data to define the use of predefined chat stickers and/or face filters, themes/background images, image enhancement, and emoji data to be incorporated into the message before it is sent to the web server 106. In step 614, the mobile application receives user specified message time data. The message time data may specify when the message is to be sent it its recipient and when it is to be deleted if deletion is enabled. The message time data may also include definition of alarms to be included in the message. The mobile application 106 uses all of the received data to create an initial draft of the message in step 615. The mobile application 106 then modifies the initial draft message using the remaining information received from the user.

In test step 621, the mobile application 106 determines whether user specified modification data included a predefined chat sticker or face filter, and a predefined chat sticker instructions on application of a predefined chat sticker or filter to the user image, video stream, or profile picture; and when it is present, the mobile application 106 applies the predefined chat sticker or filter to the images included within the message in step 622 and proceeds to test step 623. If the predefined chat sticker or face filter instructions are not present in the user data, the process 600 proceeds directly to test step 623.

In test step 623, the mobile application 106 determines whether user specified modification data includes a background modification instruction on application of a background image to the user image, video stream, or profile picture; and when it is present, the mobile application 106 applies the background image to the images included within the message in step 624 and proceeds to test step 625. If the background modification instructions are not present in the user data, the process 600 proceeds directly to test step 625.

In test step 625, the mobile application 106 determines whether user specified modification data includes a message delete modifications instruction as to when the message is to be deleted off of its intended feed; and when it is present, the mobile application 106 includes message delete instruction to the web server 105 within the message in step 626 and proceeds to test step 627. If the message time instructions are not present in the user data, the process 600 proceeds directly to test step 627.

In test step 627, the mobile application 106 determines whether user specified modification data includes a message scheduling modifications instruction as to when the message is to be sent to its intended recipient or relevant feed; and when it is present, the mobile application 106 includes message scheduling instruction to the web server 105 within the message in step 628 and proceeds to test step 629. If the message time instruction is not present in the user data, the process 600 proceeds directly to test step 629.

In test step 629, the mobile application 106 determines whether user specified recipients of the message are friends or followers of the user. When the user specified recipients are friends and followers is present, the mobile application 106 proceeds to test step 630. If the user specified recipients are not present in the friends and followers lists for the user, the process 600 ends 602.

In test step 630, the mobile application 106 determines whether user specified recipient verification data includes a receipt verification instruction to provide the user a message read receipt as to when the message is intended to be created or initiated on the relevant feed; and when it is present, the mobile application 106 includes the receipt verification instruction to the web server 105 within the message in step 631 and proceeds to test step 632. If the receipt verification instruction is not present in the user data field, the process 600 proceeds directly to test step 632.

In step 632, the mobile application 106 transmits the completed message to the web server 105 for transmission to the intended recipients, which may include all other users who have access to the message feeds and chat sessions. When the web server 105 confirms receipt of the transmitted message, process 600 ends 602.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control, and transfer of content(s) or data between any combination of the components.

What is claimed is:

1. A system for providing a multi-feed mobile chat platform for separate business, professional, personal, and private uses between a mobile application on a client device, the system communicatively connects a web server and a plurality of the client devices over the Internet, the client devices operate the mobile application, the client device comprises:
a memory having instructions stored thereon; and
a processor configured to execute the instructions within a mobile application in the memory to cause the electronic client device to send and receive message from other users;
the mobile application comprises a set of software components comprises:
a message generator;
a user command processor;
a normal post component;
a schedule-a-post component;
a direct messaging component;
a fun chat dialog component;
a live streaming component;
a vanishing message component;
a recipient(s) verification or confirmation component; and
a billboard message component.

2. The client device according to claim 1, wherein the mobile application further comprises:
a user registration component;
a social login component;
a message search component;
a user profile component;
a create post component;
add friend/follower component;
an audio note component;
an audio and video call component;
a predefined chat sticker or face filter component;
an emoji component;
a themes/background component;
a friends list component; and
an incentivized marketplace component.

3. The client device according to claim 1, wherein the message generator component receives user data from the user to create and edit a draft posted message before the user instructs the message generator component a to send the draft posted message to the social media web server.

4. The client device according to claim 4, wherein the message generator component utilizes the normal post component. to accept data from the user to create a draft message for transmission to the web server permitting the user to post on the feed by the time of creation.

5. The client device according to claim 4, wherein the message generator component utilizes the schedule-a-post component adds any user specified time data associated with the draft message to instruct the web server when to post the message onto one or more of the feeds;
wherein the schedule-a-post component utilizes the vanishing message component adds user specified deletion time data to the draft message before it is sent to the web server, the web server deletes the corresponding message when the specified deletion time is reached.

6. The client device according to claim 6, wherein the schedule-a post component further includes a timer component to preschedule a post, an alarm component to provide a visual and auditory indication that a user defined alarm has passed;
wherein the schedule-a post component utilizes the vanishing message component adds user specified deletion time data to the draft message before it is sent to the web server, the web server deletes the corresponding message when the specified deletion time is reached.

7. The client device according to claim 4, wherein the message generator component utilizes the vanishing message component adds user specified deletion time data to the draft message before it is sent to the web server, the web server deletes the corresponding message when the specified deletion time is reached;
wherein the vanishing message component utilizes the schedule-a post component further includes a timer component to preschedule and/or pre-delete a post, an alarm component to provide a visual and auditory indication that a user defined alarm has passed; and
wherein the vanishing message component utilizes the schedule-a-post component adds any user specified time data associated with the draft message to instruct the web server when to post the message onto one or more of the feeds.

8. The client device according to claim 4, wherein the message generator or text input field component utilizes the recipient verification or confirmation component adds user specified recipient verification requests data to a text input field via a visual and/or an auditory indication before a user types, keys and chat, the user's text input field detects when a specified user is about to create or initiate a chat and text message.

9. The client device according to claim 1, wherein the message generator component utilizes the direct messaging component accepts user data to create the above messages, transmits the messages to specified users, receives messages from other users, and presents all sent and received messages to the user.

10. The client device according to claim 1, wherein the message generator component utilizes the fun chat dialog component creates the chat messages, transmits the chat messages to specified users, receives chat messages from other users, and presents all set and received chat messages to the user, including use of the Themes/Background component, the Predefined Chat Stickers, and Face Filters component.

11. The client device according to claim 2, wherein the message generator component utilizes the live streaming component accepts multi-media data that is to be streamed to other users, the Live Streaming component modifies, improves, and enhances the streaming data before transmission including use of the Themes/Background component, the Predefined Chat Sticker and Face Filters component.

12. A system for providing a multi-feed mobile chat platform for separate business, professional, personal, and private uses between a mobile application on a client device, the system communicatively connects a web server and a plurality of the client devices over the Internet, the client devices operate the mobile application, the client device comprises:
a memory having instructions stored thereon; and
a processor configured to execute the instructions within a mobile application in the memory to cause the electronic client device to send and receive message from other users;
the mobile application comprises a set of software components comprises:
a message generator, the message generator component utilizes an billboard message, marketing, and advertising component;
a user command processor;
a schedule-a-post component;
a direct messaging component;
a vanishing message component;
a recipient(s) verification or confirmation component; and
an incentivized buy and sell marketplace component, the incentivized buy and sell marketplace component allows a user to create a listing to sell item on the marketplace, enables a user to offer or employ an incentivize business model in the selling of the user's goods and services in the offering of discounts, allows buyers to save in the marketplace incentivize business model by buying any item in the marketplace on a discounted price, communicate, and transact business with other users, and to search and view items contained in the marketplace.

13. A method for providing a multi-feed mobile chat platform for separate business and personal uses between a web server and a plurality of client devices communicatively connected over the Internet, the method comprising:
receiving user message data, the user message comprises user message content data, user specified message type data, user specified message modification data, and user specified message time data;
generating a draft message using the user message data;
when user specified message modification data contains predefined chat sticker or face filter instruction data, apply a predefined chat sticker or face filter to all images associated with the user contained in the draft message.
when user specified message modification data contains predefined chat sticker and face filter instruction data, apply a background to all images associated with the user contained in the draft message;
when user specified message time data contains message deletion instruction data, insert a deletion time instruction into the draft message to cause the web server to delete the message at the data and time specified in the deletion time instruction;
when user specified message time data contains message schedule instruction data, insert a scheduled posting time instruction into the draft message to cause the web server to preschedule a posting and/or delete the message or posting at the data and time specified in the deletion time instruction; and
send the draft message data, including any modifications to the draft message to the web server for inclusion in one of a plurality of message feeds.

14. The method according to claim 13, wherein the draft message further comprises message type data indicating the feed and recipient users of the draft message.

15. The method according to claim 13, wherein message type data comprising a user business message feed, a user personal feed, a dual user messaging and chat feeds, a live streaming feed, a marketplace feed, and a billboard feed.
